(19) United States
(12) Patent Application Publication
(10) Pub. No.: US 2002/0103905 A1
(43) Pub. Date: Aug. 1, 2002

(54) Method and system for providing business partners with access to a company's internal computer resources

(76) Inventor: Prabahkar Subramaniam, Boise, ID (US)

Correspondence Address: DORSEY & WHITNEY LLP, SUITE 3400, 1420 FIFTH AVENUE, SEATTLE, WA, 98101, US

(21) Appl. No.: 09/775,014

(22) Filed: Jan. 31, 2001

(51) Int. Cl. G06F 15/173; G06F 15/16

(52) U.S. Cl. 709/225; 709/219

(57) ABSTRACT

A method and system provide users access to a company's internal computer resources without the need for a custom communications network, while not jeopardizing the security of the internal computer resources. One method includes, under control of a client computer, initiating a user request to access a desired computer resource in a target computer. Under control of an interface component on a server computer, receiving the user request and initiating a remote invocation of a user component object on the target computer responsive to the user request. The target computer receives the remote invocation and, in response to the remote invocation, the user component object is invoked to access the desired computer resource and obtain user information from the accessed computer resource. The user component object returns the user information to the interface component which, in turn, sends the user information to the client computer.

### TECHNICAL FIELD

The present invention relates generally to computer systems, and more particularly to providing third parties access to a companies internal computer resources.

### BACKGROUND OF THE INVENTION

In today's global business environment, a company may have numerous business partners with which information must be exchanged to facilitate business transactions. For example, where the company is a supplier of a product, business partners that purchase the product may need access to the company's internal computer resources, such as inventory databases and product pricing, when ordering the product. For example, a business partner may want to place an order for a predetermined quantity of the product, and before placing such an order may desire to check the company's inventory of the product. Moreover, a business partner may be provided access to other internal computer resources, such as internal Web sites and custom software packages, which may contain a variety of useful information on the product and assist the business partner, for example, in integrating the product into the partner's system.

Typically, to provide business partners with access to a company's internal computer resources a custom communications network, such as an electronic data interchange (EDI) network, is established between the company and the business partners. FIG. 1 is a functional block diagram illustrating a conventional EDI network 100 including a value added network 102 that provides a plurality of business partners 104-108 with access to internal computer resources 110 of a company 112, as will now be explained more detail. The value added network 102 is a communications network that communicates with each of the business partners 104-108 and the company 112 via respective communications links. Each communications link may provide authentication and encryption to ensure secure communication between the value added network 102 and the respective business partners 104-108 and company 112.

In operation, the value added network 102 receives messages from the business partners 104-108 and the company 112 and forwards each message to the appropriate recipient. For example, if the business partner 104 desires to access a particular internal computer resource 110 in the company 112, the business partner sends a corresponding request to the value added network 102 which, in turn, forwards the request to the company 112. In response to the request from the value added network 102, the internal computer resources 110 process the request and return to the value added network 102 a message containing a response to the request. The value added network 102 then forwards the message to the business partner 104 as the response to the business partner's initial request. As will be appreciated by those skilled in the art, the value added network 102 enables the company 112 to communicate with many business partners 104-108 without requiring a separate communications link with each business partner.

In the EDI network 100, the messages communicated between the business partners 104-108 and the company 112 via the value added network have a predetermined message format agreed upon by the business partners and the company. Each business partner 104-108 that is to be provided with access to the internal computer resources 110 must agree upon the same predetermined message format. For example, assume the business partners 104-108 are distributors of the company 112, and that each such distributor is provided with the same access to the internal computer resources 110. In this example, all of the distributors must agree upon the same message format and configure their respective internal computer systems (not shown) to communicate with the value added network 102 according to this message format. Any new distributors that the company 112 later enters into contracts with must also utilize the same message format in order to become a member of the distributor network and have access to the internal computer resources 110. The company 112 may also have other groups of business partners 104-108, such as suppliers, which require different types of access to the internal computer resources 110. For each such group of business partners 104-108, corresponding predetermined message formats must be agreed upon by the company 112 and the business partners.

While the EDI network 100 securely provides each business partner 104-108 with the desired access to the internal computer resources 110 of the company 112, the costs of establishing such a network can be quite high. This is true because the EDI network 100 is a custom network that is being created between the company 112 and the business partners 104-108, with the company and each business partner agreeing upon the detailed specifications of the network including the type of data to be exchanged, message formats and protocols, and so on.

There is a need for providing a third party such as a business partner with access to a company's internal computer resources without jeopardizing the security of the internal resources and without forming a special network, such as an EDI network, between the company and the business partners.

### SUMMARY OF THE INVENTION

A method and system provide users with access to a company's internal computer resources without the need for a custom communications network, while not jeopardizing the security of the internal computer resources. According to one aspect of the present invention, a method of provides a user access to computer resources on a target computer system. The method includes, under control of a client computer system, initiating a user request to access a desired computer resource in the target computer system. Under control of an interface component on a server computer system, receiving the user request and initiating a remote invocation of a user component object on the target computer system in response to the user request. The remote invocation is received on the target computer system and, in response to the remote invocation, the user component object is invoked to access the desired computer resource and obtain user information from the accessed computer resource. The user component object returns the user information to the interface component on the server computer system which, in turn, sends the user information to the client computer system.

### BRIEF DESCRIPTION OF THE DRAWINGS

FIG. 1 is a functional block diagram illustrating a conventional electronic data interchange (EDI) network for providing a number of business partners with access to a company's internal computer resources.

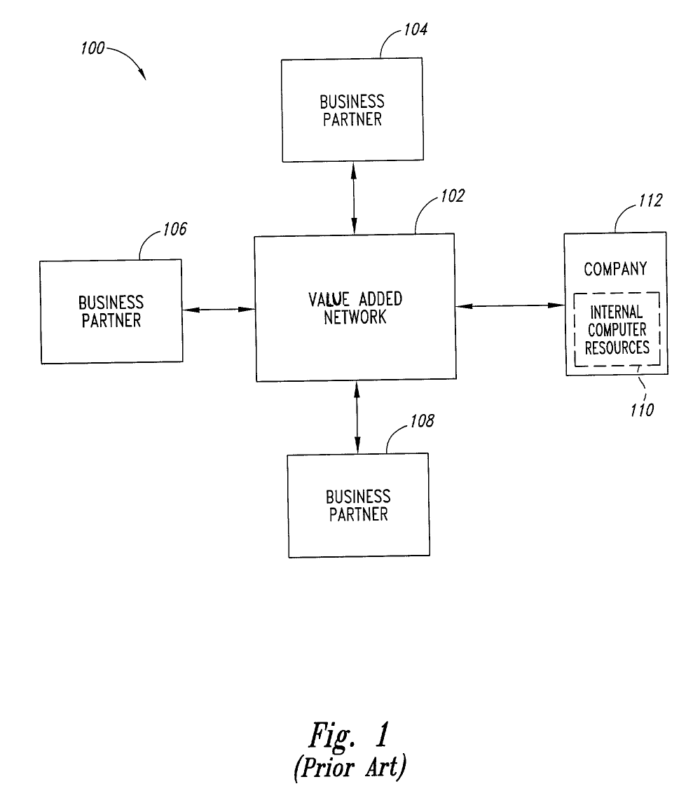

FIG. 2 is a functional block diagram illustrating a computer system for providing business partners with access to a company's internal computer resources according to one embodiment of the present invention.

### DETAILED DESCRIPTION OF THE INVENTION

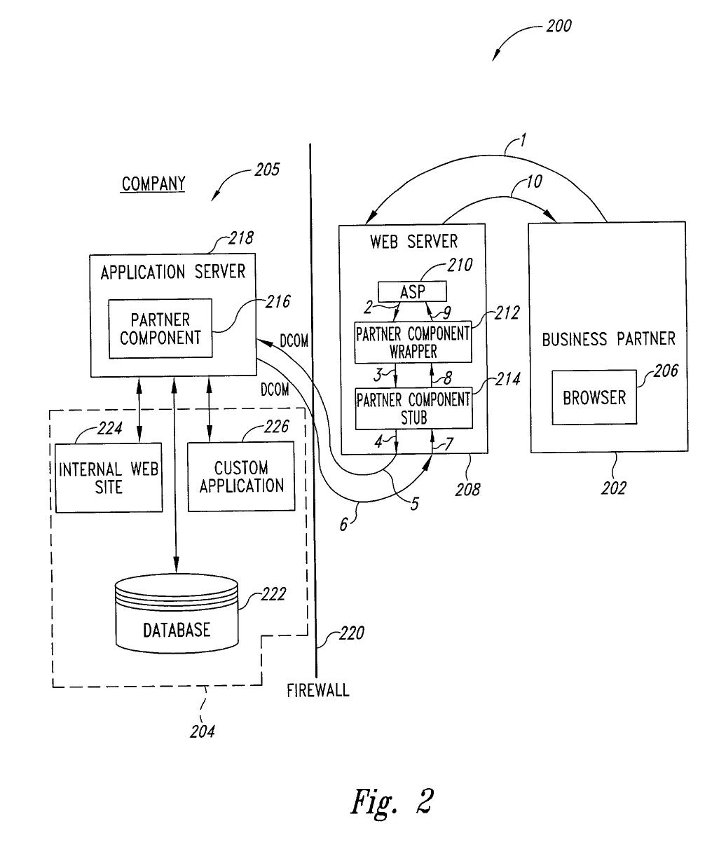

FIG. 2 is a functional block diagram illustrating a computer system 200 for providing a business partner computer system 202 with access to internal computer resources 204 on a company's internal computer system 205 without the need for establishing an EDI or other custom network, as will now be explained in more detail. In FIG. 2, the arrows 1-10 indicate the flow of communication between components within the computer system 200, and will be discussed in more detail below when discussing the overall operation of the computer system. In the following description, certain details are set forth to provide a sufficient understanding of the invention. However, it will be clear to one skilled in the art that the invention may be practiced without these particular details. In other instances, well-known components, timing protocols, software operations, and similar details have not been described in depth in order to avoid unnecessarily obscuring the invention.

In the computer system 200, the business partner computer system 202 includes a Web browser 206 or other suitable program for communicating with a company Web server 208 via the World Wide Web, Internet, or other suitable communication network. The Web server 208 corresponds to the company's Web server that provides not only business partners but all Web users with access to various information about the company that is posted on the Web server. The Web server 208 includes an active server page (“ASP”) 210 that receives requests from the browser 206, processes the received requests to generate a corresponding Web page, and returns the generated Web page to the browser. The ASP 210 dynamically creates a Web page corresponding to the received request from the browser 206, as will be appreciated by those skilled in the art. The communication between the browser 206 and the ASP 210 may be done using a secure protocol, such as the Secure Sockets Layer, to provide for the secure communication of data between the business partner computer system 202 and the Web server 208. For example, the ASP 210 may store a password on the Web server 208 to provide authentication of the browser 206, and a private key can be utilized to encrypt and decrypt data transferred between the browser and the ASP. The ASP 210, along with all components on the Web server 208, may run under an environment such as Microsoft Transaction Server or other suitable server platform.

The Web server 208 further includes a partner component wrapper 212 that is initiated by the ASP 210 as part of the process of generating the Web page to be returned to the browser 206. The partner component wrapper 212 translates data from a first format that is utilized by the ASP 210 to a second format that is utilized by other components in the system 200, and also performs the reverse translation. For example, the partner component wrapper 212 may translate HTML data received from the ASP 210, which corresponds to the data format of a conventional Web page, to a second data format such as a database query language format. The partner component wrapper 212 also performs the reverse translation, translating data in the second data format to HTML data when the second data format is received by the partner component wrapper.

Once the partner component wrapper 212 has performed the required data translation, the wrapper calls a partner component stub 214 that is stored on the Web server 208. The partner component stub 214 corresponds to a portion of a partner component object 216 stored on an application server 218 that is part of the company's internal computer system 205. To the partner component wrapper 212 making the call, the stub 214 looks like the partner component object 216 stored on application server 218. The partner component stub 214 includes all required information for remotely invoking the partner component object 216, as will be appreciated by those skilled in the art.

In response to the call from the partner component wrapper 212, the partner component stub 214 remotely invokes the partner component object 216 through the distributed component object model (“DCOM”) architecture, as will be understood by those skilled in the art. The DCOM architecture allows component objects on different computers to be utilized, where a component object is an object that executes predetermined functions in response to commands or calls supplied to the object. Each component object has a predetermined interface that defines the calls that may be applied to the object and the data returned in response to such calls. The DCOM architecture allows application programs to utilize previously developed component objects to perform desired functions, and thereby greatly reduces the programming time to develop such application programs. The DCOM architecture also provides secure communication between the partner component stub 214 and the partner component object 216 by, for example, authenticating a user name associated with the partner component stub 214 making the call, and thereafter determining whether the user name has access to the requested partner component object 216. The DCOM architecture is well understood by those skilled in the art, and thus, for the sake of brevity, will not be described in more detail. Although the computer system 200 uses the DCOM architecture in the embodiment of FIG. 2, other suitable architectures such as the Distributed System Object Model (DSOM) may also be used.

As illustrated in FIG. 2, a firewall 220 is interposed between the application server 218 and the Web server 208, and the communications between the partner component stub 214 and the partner component object 216 via the DCOM architecture are through the firewall component. The firewall 220 is functionally positioned between the internal computer system 205 and the Web server 208 and monitors all messages entering or leaving the internal computer system, allowing only those messages that meet specified security criteria to pass to or from the internal computer system. As will be appreciated by those skilled in the art, the primary function of the firewall 220 is to prevent unauthorized external users from accessing the internal computer system 205.

The partner component object 216 accesses associated internal computer resources 204 in response to the remote call from the partner component stub 214, and thereafter returns data obtained from the accessed computer resource to the stub via the DCOM architecture. The partner component object 216 is written to provide the business partner with access to specific internal computer resources 204 of the company, which may include an internal database 222, various internal company Web sites 224, and internal custom applications 226 that are typically accessible only to employees of the company. The functionality of the partner component object 216 and thereby the internal computer resources 204 to which a particular business partner is provided access may depend upon the type and nature of the business partner. For example, the partner component object 216 may provide a distributor of the company's product with access to inventory information on the internal database 222, while the partner component may provide a joint technology partner of the company with access to internal Web sites 224 and internal custom applications 226.

The overall operation of the computer system 200 will now be described in more detail using the arrows 1-10 which, as previously mentioned, illustrate the process flow between the components of the computer system. In operation, the browser 206, operating under control of a user of the business partner computer system 202, contacts the ASP 210 on the Web server 208 as indicated by the arrow 1 and requests a Web page from the server. In response to the received request, the ASP 210 initiates the partner component wrapper 212 as indicated by the arrow 2, and the partner component wrapper 212 translates data contained in the request from HTML data to another data format, such as a database query language format. The partner component wrapper 212 thereafter calls the partner component stub 214 as indicated by the arrow 3, and the stub remotely invokes the partner component object 216 as indicated by the arrow 4 through the DCOM architecture, which is illustrated by the arrow 5. As previously mentioned, the DCOM architecture communicates between the partner component object 216 and the stub 214 through the firewall 220. In response to the call from the stub 214, the partner component object 216 accesses the requested internal computing resource 204 and thereafter returns data obtained from the accessed computer resource via the DCOM architecture (arrow 6) to the partner component stub (arrow 7). The partner component stub 214 provides the data received from the partner component object 216 to the partner component wrapper 212 (arrow 8) which, in turn, translates the data from its current format to HTML data which is thereafter applied to the ASP 210 as indicated by the arrow 9. The ASP 210 utilizes the data received from the partner component wrapper 212 to generate a Web page corresponding to the initial request received from the browser 206, and thereafter returns this Web page to the browser as indicated by the arrow 10.

The computer system 200 allows the business partner 202 to access internal computer resources 204 on the company's internal computer system 205 using a conventional Web browser 206 while not jeopardizing the security of the internal computer system. No custom communications network, such as an EDI network, is required with the computer system 200, and any number of business partners 202 may be provided access to the internal computer resources 204 simply by configuring corresponding components on the Web server 208 and the application server 218. The security of the internal computer system 205 is protected at several levels in the computer system 200. First, communications between the browser 206 and the ASP 210 on the Web server 208 may be through a secure communications protocol. In addition, the DCOM architecture also provides added security for communications between the partner component stub 214 on the Web server 208 and the partner component object 216 on the application server 218. Finally, the firewall 220 provides added security for preventing unauthorized communications to and from the internal computer system 205.

It is to be understood that even though various embodiments and advantages of the present invention have been set forth in the foregoing description, the above disclosure is illustrative only, and changes may be made in detail, and yet remain within the broad principles of the invention. For example, many of the components described above may be implemented using either digital or analog circuitry, or a combination of both, and may be realized through software executing on suitable processing circuitry. Therefore, the present invention is to be limited only by the appended claims.

1. A method of providing a user access to computer resources on a target computer system, the method comprising:
under control of a client computer system, initiating a user request to access a desired computer resource in the target computer system;
under control of an interface component on a server computer system, receiving the user request and initiating a remote invocation of a user component object on the target computer system in response to the user request; and
receiving the remote invocation on the target computer system and, in response to the remote invocation, invoking the user component object to access the desired computer resource and obtain user information from the accessed computer resource, the user component object returning the user information to the interface component on the server computer system which, in turn, sends the user information to the client computer system.

2. The method of claim 1 wherein a Web browser executing on the client computer system initiates the user request.

3. The method of claim 1 wherein initiating the remote invocation corresponds to a distributed component object model communication, and the user component object returns the user information via a distributed component object model communication.

4. The method of claim 1 wherein the interface component includes an active server page through which the user request is received and the corresponding user information is provided to the client computer system.

5. The method of claim 4 wherein communication between the active server page component and the client computer system comprises communication via a secure communications protocol.

6. The method of claim 1 wherein receiving the remote invocation on the target computer system and returning the user information to the interface component on the server computer system includes authenticating the interface component that initiated the remote invocation and determining whether the interface component has access to the user component object.

7. The method of claim 1 wherein the target computer system corresponds to a company's internal computer system and the client computer system corresponds to a business partner of the company, and the user request corresponds to business information stored on the company's internal computer system that the business partner is permitted to access.

8. A method of providing a user access to computer resources on a target computer system, the method comprising:
under control of an interface component on a server computer system,
receiving a user request to access a desired computer resource in the target computer system;
initiating a remote invocation of a user component object on the target computer system in response to the received user request;
under control of the user component object on the target computer system,
receiving the remote invocation;
in response to the remote invocation, invoking the user component object to access the desired computer resource and obtain user information from the accessed computer resource;
returning the user information to the interface component on the server computer system; and
under control of the interface component on the server computer system, providing the returned user information to a sender of the user request.

9. The method of claim 8 wherein the user request corresponds to an HTTP request received from a Web browser.

10. The method of claim 8 wherein initiating the remote invocation corresponds to a distributed component object model communication, and the user component object returns the user information via a distributed component object model communication.

11. The method of claim 8 wherein the interface component includes an active server page through which the user request is received and the corresponding user information is provided to the client computer system.

12. The method of claim 11 wherein communication between the active server page and the client computer system comprises communication through a secure communications protocol.

13. The method of claim 8 wherein receiving the remote invocation and returning the user information to the interface component on the server computer system includes authenticating the interface component that initiated the remote invocation and determining whether the interface component has access to the user component object.

14. The method of claim 8 wherein the target computer system corresponds to a company's internal computer system and the client computer system corresponds to a business partner of the company, and the user request corresponds to information stored on the company's internal computer system that the business partner is permitted to access.

15. A system for providing a remote user with access to resources on a computer system, comprising:
a first server computer system including a plurality of computer resources and including a user component object, the user component object being adapted to receive a remote invocation and operable in response to the remote invocation to access a computer resource and obtain corresponding user information, the user component object outputting the obtained user information; and
a second server computer system coupled to the first server and including an interface component that is adapted to receive a user request to access a desired computer resource, the interface component applying the remote invocation to the user component object in response to the received user request, and the interface component receiving the obtained user information corresponding to the applied remote invocation and providing the user information to a sender of the user request.

16. The computer system of claim 15 wherein the user component object comprises a DCOM object.

17. The computer system of claim 15 wherein the second server computer system comprises a Web server.

18. The computer system of claim 15 wherein the first server computer system further comprises a firewall coupled between the first and second server computer systems, the firewall monitoring each communication between the first and second computer systems and permitting only communications that satisfy specified security criteria.

19. A computer system for providing a user access to resources on the computer system, comprising:
a first server computer system including
an active server page adapted to receive user requests from a browser program, the active server page operable in response to the user request to generate a page data request and to receive page data responsive to the page data request, and the active server page providing a Web page including the received page data to the browser;
a component object wrapper coupled to the active server page, the component object wrapper translating data in the page data request into a second data format and generating a component call responsive to receiving the page data request from the active server component, and the component object wrapper receiving user data corresponding to the component call and translating the user data into page data and returning the page data to the active server page;
a component object stub coupled to the component object wrapper, the component object stub generating a remote invocation command responsive to the component call from the component object wrapper and being adapted to receive user data returned in response to the remote invocation and to provide the user data to the component object wrapper; and
a second server computer system coupled to the component object stub, the second server computer system including a plurality of computer resources and further including a user component object, the user component object accessing the plurality of computer resources to obtain user data in response to the remote invocation command and returning the user data to the component object stub.

20. The computer system of claim 19 wherein the user component object comprises a DCOM object.

21. The computer system of claim 19 wherein the second server computer system further includes a firewall component that monitors communications to and from the second server computer system including the remote invocation commands and returned user data communicated between the user component object and the component object stub and permits only communications that satisfy specified security criteria.

22. The computer system of claim 19 wherein the first server computer system comprises a Web server.
